(19) United States
(12) Patent Application Publication
(10) Pub. No.: US 2011/0320349 A1
(43) Pub. Date: Dec. 29, 2011

(54) RENTAL PROPERTY PAYMENT SYSTEM

(76) Inventors: Leslie Olsen, Oakland, CA (US); Emiko Gordon, Thornton, CO (US); Alan Lane, Birchwood, TN (US); Eric Hathaway, Lakeville, MN (US)

(21) Appl. No.: 12/824,996

(22) Filed: Jun. 28, 2010

(51) Int. Cl. G06Q 40/00; G06Q 50/00

(52) U.S. Cl. 705/40; 705/314

(57) ABSTRACT

A system operated by a non-bank financial institution (NBFI) for receiving and processing payments made by renters to property management companies, and method of use therefor, are disclosed. The NBFI provides an electronic payment platform for accepting payments from renters of one or more rental communities owned or managed by one or more property management companies. The NBFI platform processes and directs rental payment to the payment processing systems of a partner bank or other financial institution which has bank accounts owned by the rental communities or property management companies. The partner bank directs the renters' payments into the appropriate account after processing. The NBFI creates and maintains records of all such transactions which are received through its platform, and provides the partner bank and rental communities with access to records in standardized format, such as a format compatible with existing property management or bank software, including any processing and convenience fee information.

### TECHNICAL FIELD

The present application relates to the field of electronic payment processing through Internet or network-based interfaces, and more particularly to a system and method of providing a platform for the processing of rental payments to property management companies.

### BACKGROUND

Internet-based online payment, or other modes of remote electronic payment for goods or services, or payments of installments on a variety of obligations, is common at the present time. For example, a customer may log onto a website maintained by his electric utility, call up a display of his current billing, select a payment method, such as a credit card, debit card or electronic check, enter the appropriate authorizing information, and click “submit.” Funds are transferred and an electronic receipt is displayed, and often a receipt is emailed to the customer. Convenience to the customer and provider is manifest: an immediate payment and receipt are generated without the need of the customer to travel to make the payment or write and mail a check; moreover, these transactions may be processed 24 hours a day, 7 days a week, and an electronic record is created at the outset.

The rental property industry, made up of property management companies and building owners that rent residential or commercial real estate to tenants, can benefit from the convenience and data efficiency of a web-based or other electronic system for payment and collection of rent. While some property owners collect rent directly from tenants, many large-volume building owners depend upon property management companies to administer the collection of rents and eviction of non-paying tenants, among other duties.

Tenants often pay rent with a personal check or money order sent by mail to property management companies. This common method is a problem for many property management companies, because the handling and processing of many personal checks or money orders is time consuming and a significant administrative expense. It also introduces the opportunity for erroneous data to enter the property management company's accounting systems.

Tenants are also inconvenienced by this method. Some tenants have no bank account and would prefer to pay by means other than a check. Tenants frequently desire to pay by credit or debit card in order to earn points on their card accounts. Tenants also prefer using electronic payment methods in order to schedule when the payment is withdrawn from their accounts. In general, tenants typically prefer a variety of different options with which to pay their rents.

In recent years, a variety of non-bank financial institutions (NBFIs) have provided payment services using a number of convenience portals and multiple payment modes, which include, for example, credit card, debit card, Automated Clearing House (ACH), and others, charging a convenience fee for the payment. For the reasons mentioned above, many property management companies prefer these types of payments over the standard check or money order. These methods are convenient for the tenants and easier for the property management companies to track. Further, the electronic payment records permit the export of payment data directly from NBFI systems to property management company data processing systems.

To process these rent payment transactions, NBFIs have not only built the payment portals and data processing systems to support these, but have developed or contracted with payment processing systems for the different payment modes. NBFIs have traditionally used their own payment processing systems, or they have relationships with selected third party payment processors to perform the payment processing, including credit card, and ACH, among others. NBFIs settle the transaction by depositing the rent amount to a property owner's or its property management company's account, and the property management companies pay the NBFI for this service.

FIG. 1a schematically depicts the money flow relationship in a traditional NBFI payment system 110 that may be used by renters, where the NBFI system 110 accepts several payment modes, e.g., ACH, credit card, and Checkscan, from a plurality of renters 101-106. The NBFI's payment interface 112 captures the payment order data from whatever payment portal a renter uses. This interface 112 sorts the payment order data into various types, e.g. ACH, credit card, and Checkscan, and exchanges data with the payment method modules 114a-114c of the correct type for further processing at payment processor systems 120 that may be operated by the NBFI, or the NBFI may use some third-party processing service. The payments are processed by the payment processor systems 120, such as a credit card processing firm. The resulting payments are then directed to the bank accounts 131-134 of the property management companies or the individual rental communities, less fees or subject to a later fee settlement.

Banks and other large financial institutions keep deposit accounts for property owners and management companies, and providing rental payment services to their customers would enable the bank to keep and grow these kind of customers. However, most banks do not have a consolidated payment platform or payment platform that satisfies the rental industry requirements and regulations, or integrates with the industry's leading software solutions. In addition, some banks also provide payment processing of certain types, including credit card, ACH, and check image processing, and earn processing fees for these services. Therefore, there is an additional incentive for these banks to direct payment processing used by NBFI payment systems to their payment processing systems to make credits/deposits to property owner and management company accounts. NBFIs would like to leverage the banks' customer base in order to drive more transactions to their services.

Banks cannot pay interest on certain accounts held by property owners despite large deposits, but banks can provide such property owners with other benefits that help the banks better serve their property owner customers, including some direct economic benefits. These may include preferred rates for fees the bank may charge, e.g., for payment processing, or the bank can provide processing efficiencies based on the bank holding the property owner account. Thus, the bank can strengthen its relationship with a property owner by directly or indirectly reducing processing fees for the property owner on payments the bank handles.

Thus, it may be desirable for NBFIs to partner with banks in order to process rental payments for the banks' property owner and manager customers, but there is a need in the art for systems and methods that facilitate this partnering.

### SUMMARY

Accordingly, presently disclosed is a computer-based system operated by a non-bank financial institution (NBFI) for receiving and processing payments made by renters to property management companies, which in one embodiment includes: a memory for storing payment interface data defining interactions with a renter to receive payment order data specifying a rent payment to a specified property management company customer of an NBFI partner bank, said payment having an amount and a specified payment type; a controller responsive to a renter log-in or access to select from the memory payment interface data for an NBFI partner bank identifiable from the renter log-in or access and to drive payment interface interactions to receive payment order data; a payment intake component for applying NBFI partner bank processing rules stored by the system to process the payment order data and initiate a credit to an account of the specified property management company; a first transaction directing component for responding to the processed payment order data and specified payment type to direct a payment order record for processing to an NBFI partner bank payment processing system for the specified payment type, said NBFI partner bank payment processing system effecting a credit in the account of the specified property management company; and a billing file component for reporting to the NBFI partner bank payment orders directed to each of a plurality of property management companies that are customers of the NBFI partner bank, whereby the partner bank can settle the fees for payment processing by the partner bank payment processing systems.

While multiple embodiments are disclosed, still other embodiments of the present disclosure will become apparent to those skilled in the art from the following detailed description, which shows and describes illustrative embodiments. As will be realized, the invention is capable of modification in various aspects, all without departing from the spirit and scope of the present disclosure. Accordingly, the drawings and detailed descriptions are to be regarded as illustrative in nature, and not restrictive.

### BRIEF DESCRIPTION OF THE FIGURES

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1a depicts a prior art rental payment system of a non-bank financial institution.

FIG. 1b depicts an example rental payment system in accordance with the present disclosure, built as an adaptation of a prior art system.

FIG. 1c depicts an example rental payment system in accordance with the present disclosure.

FIG. 2 depicts an example resident portal interface in accordance with the rent payment system of the present disclosure.

FIG. 3 depicts an example rental community portal interface in accordance with the rent payment system of the present disclosure.

FIG. 4 depicts an example partner bank payment data interface in accordance with the rent payment system of the present disclosure.

FIG. 5 depicts a block outline of the functionality of example portals and interfaces of the presently disclosed system.

FIG. 6 depicts an example payment intake component and first payment directing component in accordance with the rent payment system of the present disclosure.

FIG. 7 is a high-level data structure diagram for a portion of a database with partner bank specific data used in the present disclosure.

FIG. 8 depicts an example billing file relationship diagram in accordance with the present disclosure as an extension of a prior art system.

### DETAILED DESCRIPTION

### Overview

Disclosed herein is a system that enables a bank or other financial institution to provide rental payment management services for customers who are rental property owners or property management companies. (It will be understood that the “property management company” may be either an entity separate from but acting for the property owner or a service division of a property owner. “Property management company” is intended to refer to a group that collects and manages revenue, among other responsibilities, from a rental property.) These payment management services are made available to the banks' customers via a “white label” service provided by the NBFI, as an adaptation of existing NBFI payment services. Such service is operated or hosted by the NBFI to present to partner bank customers interfaces that carry the brand of a partner bank or do not prominently feature any NBFI brand. The partner bank customers may be directed to or linked to these interfaces without noting that a provider different than the partner bank is the actual operating or hosting party. The NBFI may provide an electronic payment platform with various access portals for accepting and tracking payments from renters of one or more rental communities owned or operated by one or more property management companies. The NBFI may use in this system any or all of its current access portals, which may include internet accessible websites, phones or smart phones, agent terminals, or kiosks. Thus, the portals may function to capture payment order data as entered by the renter.

The NBFI platform as adapted for use with partner banks may process and direct a rental payment to the payment processing systems of a partner bank or other financial institution. The NBFI, using its component systems, may also direct selected payment processing activity to third party payment processing services associated with a particular payment method and a particular partner bank. Such payment processing services used with partner banks may include those directed to cards, including credit, debit, and prepaid cards, ACH, and check image processing (Checkscan) payment methods, among others. The partner bank may direct the renters' payments into the appropriate bank account after processing, which may be an account at the partner bank or at another bank, and the partner bank may receive a fee for the transaction. The NBFI may create and maintain records of all such transactions which are received through its platform, and provide the partner bank, property management companies, and rental communities with access to records in standardized format, such as a format compatible with existing property management and/or bank software. The NBFI may receive fees for transactions received into its system and processed into payments for the partner bank's property management customers. The bank may provide the property management companies a discount on the fees it charges for its role in processing the transactions, with improved payment data feeds or reports, or other benefits resulting from the processing role of the partner bank.

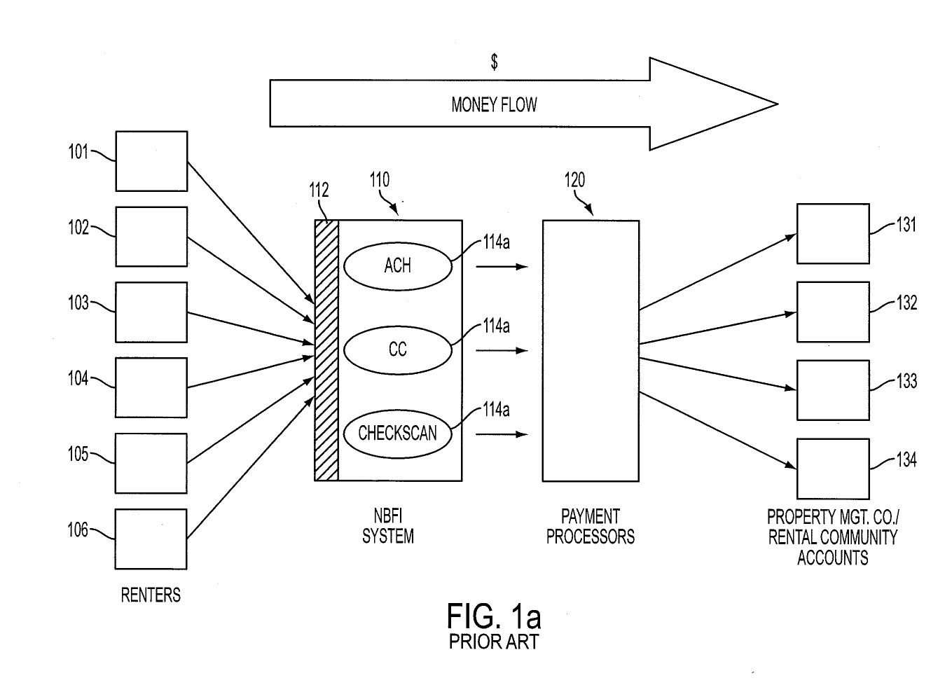

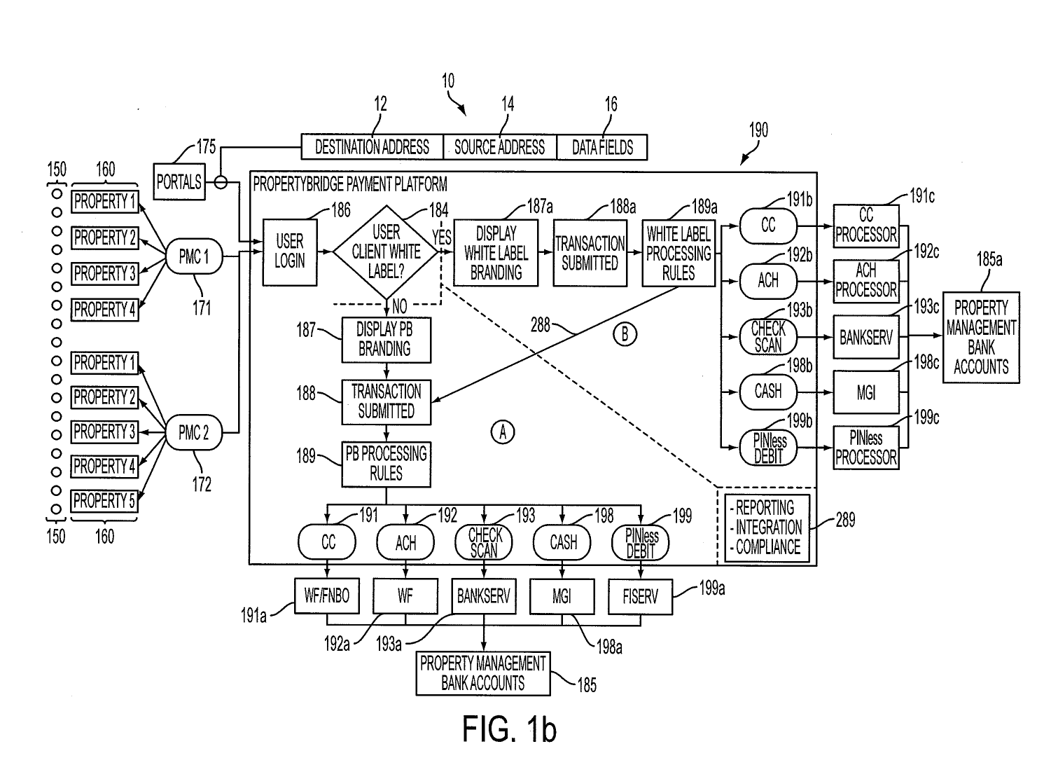

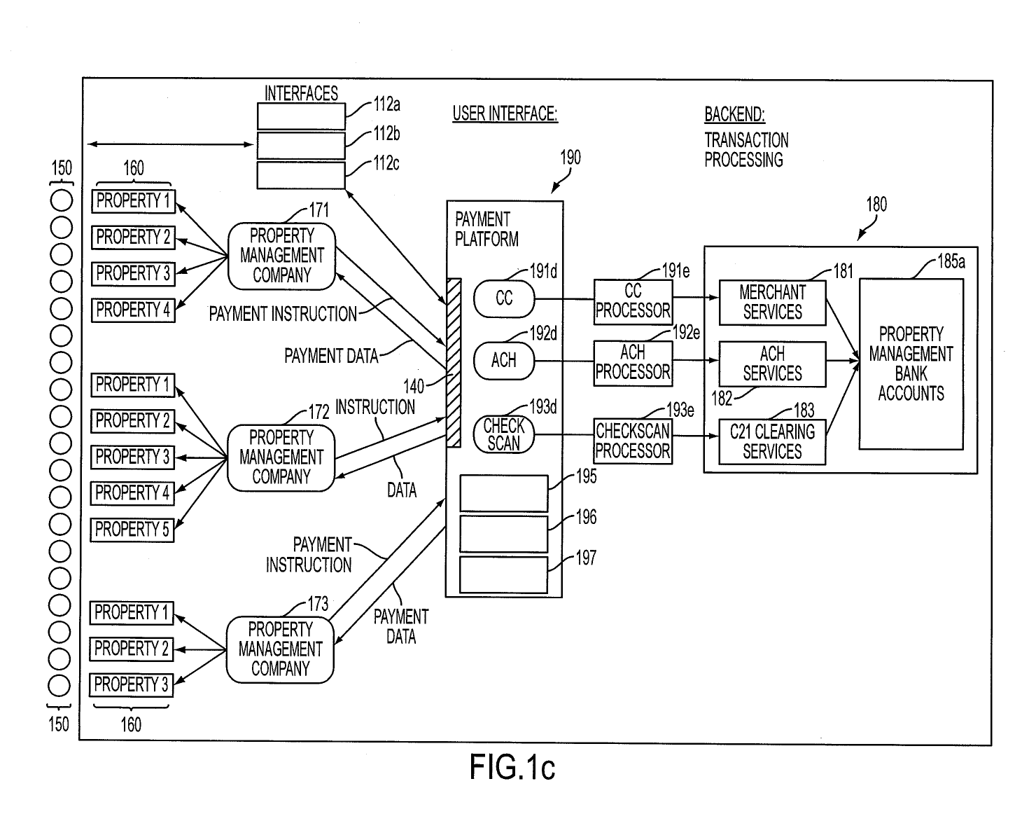

FIG. 1b shows the high level logic flow of a rental payment system of the present disclosure, built as an adaptation of NBFI systems of the prior art. In both the presently disclosed system and those known in the prior art, each renter 150 has a rent obligation at a specific rental property 160. These rental properties are owned or operated by one or more property management companies (PMC) 171, 172 (by way of example, only two are shown). In order to make a payment, a user logs into, or accesses, the payment system 190 through one of several portals, including portals accessible by residents 150, community properties 160, property management companies 171, 172, and other portals 175, as will be discussed in greater detail below. A controller component 184 receives and analyzes data from the user log-in or access (which may have various message formats depending on the portal) and, responsive to the data and messages, separates transactions which are to be processed solely through NBFI brand systems, depicted as area A within system 190 (below the diagonal dotted line), from transactions that involve a partner bank, depicted as area B above the diagonal dotted line). In one embodiment, the controller component 184 may be configured to parse incoming messages (e.g., a message 10, containing at least a destination address 12, source address 14, and data fields 16) and recognize a web address (URL) of a particular bank page or site from which the payment system is accessed, and thereby determine the appropriate partner bank white label branding to display and transaction rules to apply. For example, if a user logs into the NBFI system through a link from a webpage of the partner bank, the controller component 184 would recognize a source IP address as belonging to a specific partner bank, and route the transaction accordingly. Alternatively, the controller component may be configured to recognize a unique data field identifying a partner bank associated source from which the payment system is accessed. Other user-login recognition methods, such as solely by a unique user-assigned identification name or number, or other message-directing methods known in the art, are within the scope of the disclosure.

In the prior art NBFI systems (area A, where there is no partner bank involvement), NBFI system branding is displayed to the user at block 187. A transaction is submitted by the user 188 using an NBFI branded interface, and the NBFI uses its own rules (PB Processing Rules) to process the transaction 189 through one or more of credit card 191, ACH 192, Checkscan 193, walk-in or cash payment at an agent location 198, or Pinless debit 199 transaction processing modules and through their respective associated proprietary or NBFI-contracted third party processing channels 191a, 192a, 193a, 198a, 199a, as depicted by example in FIG. 1b. Payment is thereby ultimately deposited into property management company bank accounts 185, which may be located at one or more banks identified by the property management companies and partner banks participating in the system.

In the systems of the present disclosure, where a partner bank partners with the NBFI to process the rental payment transactions, partner bank branding 187a (identified in FIG. 1b as “white label”) is displayed to the user after the controller component 184 has identified a user as extending to system to make a payment for a rental property and property management company where a partner bank is affiliated and the property management company may have an account. In use, a renter may access the partner bank website when a payment needs to be made, and there may be a link at the partner bank website that allows the user to access the payment system of the present disclosure. The white label branding can be created by adapting the existing NBFI portals and interfaces with the partner bank branding. Thus, while to the user it may appear that the user is simply using the partner bank website to make payment, in fact the user will have been directed or electronically linked to a website (or other access portal) hosted by the NBFI system wherein white label branding is presented on the interface. The payment transaction is submitted 188a, and white label processing rules 189a are applied specific to the respective partner bank. According to the white label rules, transactions for the partner bank are submitted through partner-specific and payment-type-specific modules 191b, 192b, 193b, 198b, 199b (in a manner similar to the modules 191a, 192a, 193a, 198a, 199a used by the NBFI as described above), through their respective processing channels 191c, 192c, 193c, 198c, 199c. As noted, such processing, and associated channels, will be dependent on the partner bank associated with the transaction, and the (white label) processing rules applied must be prepared from partner bank instructions about the payment processing details for its system (data formats, transmission protocols, security protocols, data networks). The payment transaction data that is taken in by the NBFI platform must be transformed into one or more message exchanges and records sent that will be accepted by the proprietary or partner-contracted third party processing channels 191c, 192c, 193c, 198c, 199c. The payment is thereby ultimately deposited into property management company bank accounts 185a.

As can be seen, the arrangement with one partner bank as seen in FIG. 1b, area B, can be extended to alliances with other partner banks by adding further decision options to the controller component 184. As discussed above, the partner bank identity may be determined by the website from which the user initiates the transaction, e.g., a specific website of the partner bank recognizable to the controller component 184, a unique IP address, or a unique user-specific login identification name or number. What is further required for processing the transactions of an additional partner bank is that the (white label) processing rules applied for the additional partner bank must be prepared from that partner bank's instructions about the payment processing details for its systems. The payment transaction data that is taken in by the NBFI platform must be transformed into one or more message exchanges and records sent that will be accepted by the proprietary or partner-contracted third party processing channels of the additional partner bank.

White label processing rules may include a set of rules according to which a particular payment transaction is directed. White label processing rules may vary between partner banks. For example, in one embodiment, processing rules which may be applied to a credit card transaction may require the following: credit card information, which may include the card number, expiration date, name, CVV, CVS, and/or AVS, is received into the NBFI system and is passed on using industry standard security and encryption protocols. The NBFI system may store the transaction record, and pass the information along to the appropriate third party credit card processor. The third party processor may then validate the card with the card provider, process the transaction, and send a settlement file back to the NBFI. The third-party processor then directs the payment into the appropriate bank account.

In a further example, processing rules which may be applied to an ACH transaction include the following: bank account information, which may include the account and routing number, bank name, and address, is received into the NBFI system using industry standard security and encryption protocols. This information may be stored as a transaction record, and then transmitted to an ACH clearing service, such as NACHA, where the transaction is sent into the ACH network. This results in a debit to the requesting account, and a payment to the receiving account. An ACH transaction record is then returned to the NBFI system.

Referring to reference numeral 289, under all processing rules, the NBFI system presently described provides the partner bank with an integrated payment platform which complies with all applicable laws, rules, regulations, and standards regarding rental properties and rental payment. Further, at regular intervals, the NBFI system provides detailed reporting to the partner bank regarding all processed transactions, in addition to other information regarding payments at each community property, as will be discussed in greater detail below.

With more detailed reference now to the components of the presently disclosed rental payment system 190, as depicted in FIG. 1c, a renter 150 needs to make a payment (rent, application fee, security fee, for example) to a specific rental property 160. Property management companies 171, 172, and 173 own or manage one or more of the plurality of rental properties 160. Property management companies 171, 172, and 173 may have bank accounts 185a at partner bank, or any other bank 180. (While only one partner bank is shown in FIG. 1c, it will be appreciated from FIG. 1b that the presently described system may be configured with additional controller component 184 logic and processing rules to process and direct payment order data associated with any number of partner banks.) NBFI 190 may provide a payment platform comprising various interfaces or portals 112a, 112b, and 112c for use in receiving payment order data from renters 150. This NBFI payment platform is made accessible to the renter through the partner bank's websites, call-in centers, IVR (interactive voice response) systems or other “on ramps”. The payment order data flows to payment intake component 140. As opposed to the known payment intake components of the prior art, for example, payment intake component 110 (see FIG. 1a), payment intake component 140 is designed to prepare a payment record for processing, which identifies a partner bank (e.g., partner bank 180, or a different partner bank) associated with the payment order instructions received, and which is configured for processing by the appropriate payment processing service associated with the respective partner bank and the respective payment method, e.g. credit card, ACH, or Checkscan.

Property management companies may provide rental amounts due records, payment instructions, and other information to the NBFI platform so that it may be configured to receive payment from the renters at the properties owned or managed by the respective property management company. Further referring to FIG. 1c, payments orders may be initiated to the partner bank's processing pathways using credit card 191d, ACH 192d, or Checkscan 193d payment methods. The NBFI platform may direct the payment to the appropriate processing system, or third party processor 191e, 192e, 193e, depending on the respective partner banks' ability to receive and process the payment and the payment type. Credit card payments may be processed using a credit card processing company 191e and through the merchant services 181 of the partner bank. ACH payments may be processed using NACHA and the Federal Reserve (192e) and through the ACH services system 182 of the partner bank. Checkscan payments may be processed in accordance with Check 21 Act regulations by a check image processor 193e and through the Check 21 services system 183 of the partner bank. NBFI 190 may also provide various property management company customer interfaces for use at the properties 160, or for data exchanges with data processing systems at property management companies 171, 172, and 173, and at partner bank 180. These interfaces allow each of these entities to monitor payments and control portions of the payments systems disclosed herein, and to further receive reports of payments made and other payment data in standard accounting formats. The rental payment system 190, as depicted in FIG. 1c, may further include databases 195, 196, 197 for storing the tables that associate properties and property management companies with partner banks 195, that store partner bank-specific libraries of (white label) interface data or processing rules 196 and that store data from property management companies 197, such as rental amounts due records.

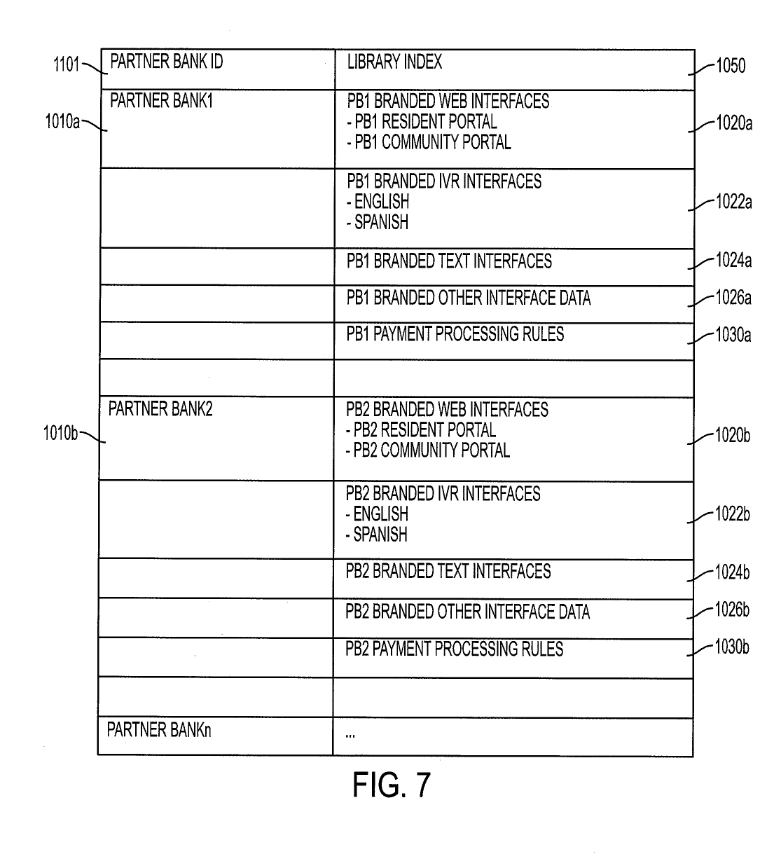

Use of the partner bank-specific white label interface data or processing rules 196 may be briefly explained with reference to FIG. 7. After logging into or otherwise accessing a partner bank web site and selecting an on-line rent payment button, a renter may be linked to one or more screens of an interface hosted by the NBFI to guide the renter through the on-line payment transaction. The screens may show partner bank logos or other graphics or visual cues that inform the renter that he/she is performing a transaction that involves the partner bank. However, the interface screens will be delivered by and the payment transaction data collected to and stored in the NBFI system 190. A similar situation may arise if the renter is directed to a toll-free call center or IVR system number. The live person or IVR systems that interacts with the renter may use an interface script that references the partner bank, but the live person or IVR system may be under control of the NBFI (and capable of using other scripts, depending on the referral source of the call).

The partner-specific libraries of interface data (which may include HTML or similar code) in database 196 may be stored for specific banks in a manner shown in FIG. 7, which shows schematically a portion of machine-readable memory used by an NBFI that works with multiple partner banks, each of which may have several interfaces by which a renter may initiate an electronic payment transaction. The data stored is labeled by a Partner Bank ID field 1101 and individual sections of the library are identified in a library index 1050. For example, the NBFI may have stored for Partner Bank1 the data/code that defines one or more Partner Bank1 branded web interfaces 1020a, which may include data/code defining interface screens, navigation and input data capture for a Partner Bank1 Resident Portal and a Partner Bank1 Community Portal. The NBFI database 196 also may have stored code/data for Partner Bank1 branded IVR interfaces 1022a (scripts in one or more languages), Partner Bank1 branded Text interfaces 1024a (messages, navigation and input data capture for a telephone-based portal) and Partner Bank1 branded other interfaces 1026a (e.g., interfaces for delivery at a device located at an NBFI agent office or for guiding a check scanning operation at a resident portal). In the same data structure where data for Partner Bank1 branded interfaces are stored, the Partner Bank1 payment processing rules 1032a also may be stored (corresponding to an instance of white label processing rules 189a; see FIG. 1b). This kind of data may also be stored for Partner Bank2, i.e., interface data (1020b, 1022b, 1024b, 1026b) and processing rules 1030b specific to the NBFI's handling of payment transactions for that second partner bank. As indicated by Partner BankN, this may be extended for many partner banks, each with its own branded interfaces and payment processing rules.

The partner bank specific data is accessed as needed. When a renter performs an access or log-in, a controller module 184 that receives data specifying the access mode and trail (linked website address, IP address, telephone referral, or other means as described above) detects the association with a partner bank. At that point this access or log-in information permits the NBFI system 190 to determine if a white label interface (or a native NBFI interface) is to be used to elicit payment transaction data. When a payment is associated with a partner bank, the system 190 selects from memory 196, the data for the particular partner bank and interface type required. This data is then used to control a driver that processes the interface data and delivers the screens, scripts or other interface elements to the renter who performed the access or log in, to gather payment transaction data and store it in NBFI system 190 for processing as required by the applicable partner bank.

### Rent Payment Interface

The presently disclosed system thus provides at least one payment interface, and preferably many interfaces, accessible through referral from an NBFI partner bank, for interacting with a renter to receive data for a rent payment order for a specified property owned or managed by a property management company customer of an NBFI partner bank. The system may also provide, accessible through the partner bank, additional non-payment interfaces used by the property management companies to monitor the rental payments being received for its properties, and by the partner bank to monitor processed payments directed into the client accounts of the rental communities or property management companies, as will be discussed in greater detail below.

In one embodiment, the system and method in accordance with the present disclosure provides a web-based payment management platform for property management companies or other rental property owners. Characteristics of the presently described system include that it is compliant and secure in accordance with all of the applicable industry standards, all municipal, state, and federal (including IRS) laws, rules, and regulations concerning rental properties and rental payments, for each type of monetary transaction processed and for handling private resident data. The NBFI already has these basic compliant and secure systems, and by adding the additional components for receiving, recognizing and custom-processing the payment transactions associated with partner banks can provide them all the benefits and efficiencies, plus processing revenue.

The NBFI system and the various available interfaces may allow the renter to make payments using a variety of payment portals and payment methods and types. For example, the renter may use a credit card or ACH or Checkscan payment from a bank account, among others payment methods. The portals (with corresponding interaction interfaces) by which payment may be initiated include online via any platform with Internet access (PC, PDA, smartphone); over conventional phone through, for example, a toll-free telephone number or other phone number and interaction by texting or interactive voice response (IVR) or live operators; or an agent location of the NBFI. The portal or device used is not significant, as long as the payor, payment amount, relevant property unit, and payment source can be specified and captured in a payment order. The various partner-bank specific website screens, IVR scripts or other interfaces driven by the stored interface data (e.g., 1020a, 1022a, 1024a, 1026a) permit the payment transaction data to be captured and stored by the NBFI system 190 just as if the payment transaction had been instructed by use of an NBFI native (non-white label) interface.

The presently described system allows for integration of the payment transaction data with existing property management software, thus allowing the property owner or property management company to process payment report data through its existing property management data platform. The property owner or property management company may thereby be enabled to integrate payments made via the system more effectively into their existing operations. Further, the system allows for standardized and consolidated access to information regarding resident payments for record-keeping purposes.

In one embodiment, the online accessible platform of the payment system described herein is accessed by a resident or other user by logging into a partner bank's website which then links the renter into the NBFI payment system and appropriate white label interface, enabling her to make a periodic rent payment (or other rental-related payment). In addition to a resident portal, in some embodiments, renters may initiate a rental payment by having a community manager enter data into a Community portal operably connected with the NBFI system. The community portal may be accessed at the management offices of the property management company, for example, and connected to the NBFI system through electronic communication means, such as the interne. The community portal may be configured to accept all payment methods as described above with regard to the resident portal. Additionally, the community portal may be configured with scanning equipment to allow the property management company to scan checks presented by the renter, thereby enabling the Checkscan method of payment discussed above. The community portal may also enable a property management company to access additional components of the NBFI payment system, including monitoring, management, data entry, validation, and billing components as will be discussed in greater detail below.

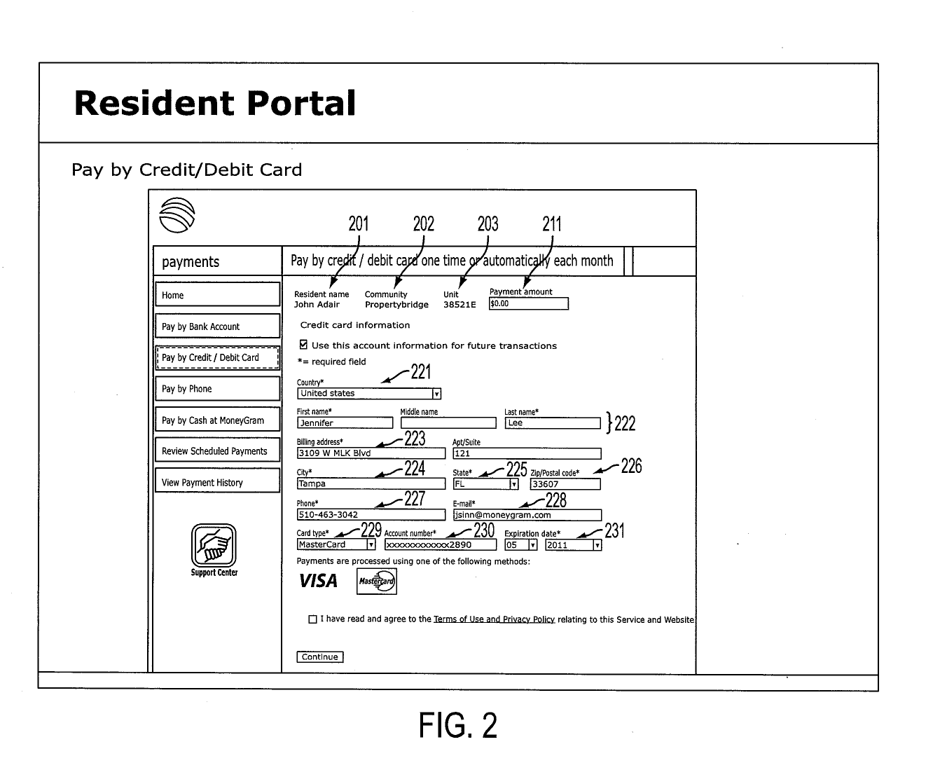

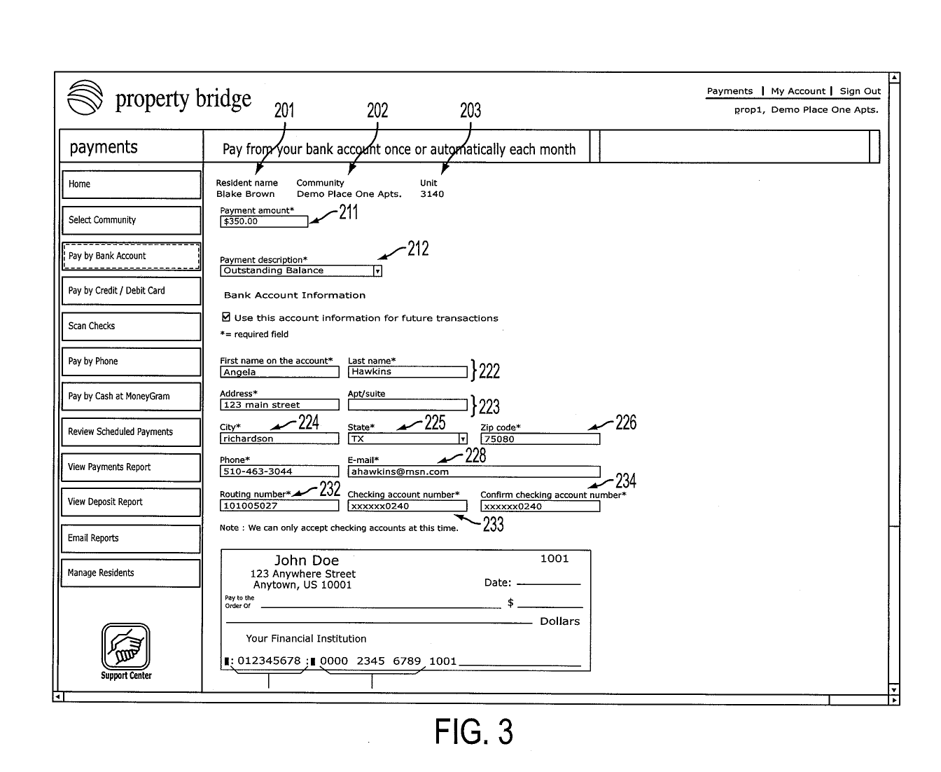

Referring now to FIGS. 2 and 3, depicted are example screen displays which may be accessible by a renter/user using username/password login credentials to her payment website, known as a “resident portal,” and which may be accessible by a community manager at a community office, known as a “community portal.” At the top of the display the resident name 201 appears confirming that the proper account has been accessed. Next to the resident name, the community name 202 appears, so as to verify the proper account location in case the user has more than one account. Next to the community name, the unit number 203 or other identifier appears, so as to verify the proper account unit in case the user rents more than one unit at a particular location.

A payment order may be entered on screen by typing in an amount directly into the payment field 211. Alternatively, in some embodiments, the user may be able to select the current amount that is owed for the user's rent, or the user may be able to select another amount and enter such amount into a field as previously discussed. In FIG. 3, a payment description selection 212 may allow the user to select the appropriate description for their payment. Other options may include security deposit or application fee.

Below the account and payment amount, the user may be able to enter payment information. The type of payment may be selected by a selection means located on the display, which as shown in FIGS. 2 and 3 as a column on the left side of the display listing different payment choices. Selected in FIG. 2, as shown on the left side column, is the “pay by credit/debit card.” Selected in FIG. 3, as shown on the left side column, is the “pay by bank account.” Thus, in these examples, the information required to be collected from the user in order to process a credit or debit card, or bank account payment is the country of residence 221, the user's first and last name 222, the user's billing address 223, the user city 224, state 225, and zip code 226, the user's phone number 227, and the user's e-mail address 228. In FIG. 2, the type of credit card 229, the account number 230, and expiration date 231 are required for a credit/debit card payment. In FIG. 3, the routing number 232, checking account number 233, and confirm checking account number 234 are required for a bank account payment. In some embodiments, where the user has previously made a credit or debit card payment, or any other payments, the information required in association such payments may be saved by the system, at the request of the user, by selecting for example a check box on the display page, which indicates that such information may be saved for future transactions. Payment orders using other payment methods may be received in a like manner, with the respective information accepted corresponding to the information required to process such payment type.

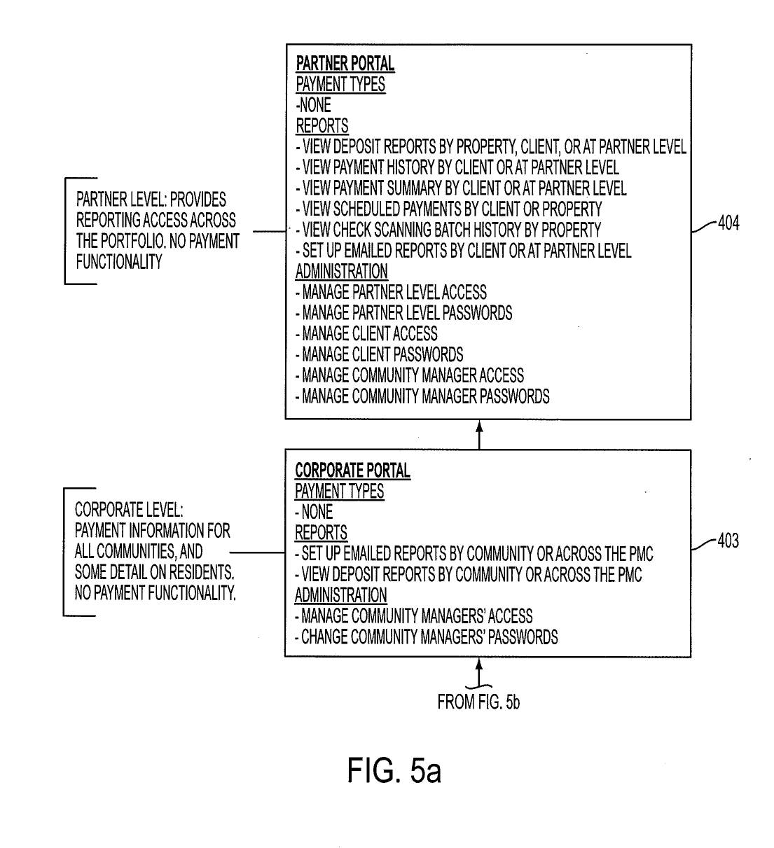

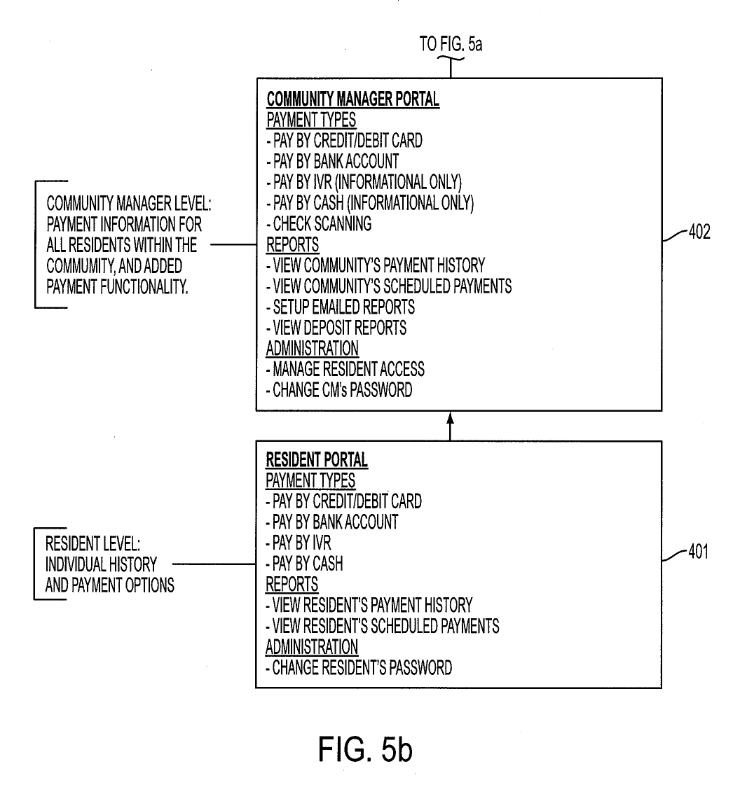

FIG. 5 depicts the functional components of the resident portal 401 and the community portal 402. As shown at block 401, the components of the resident portal 401 allow multiple methods of payment, including credit card, cash, and bank account (ACH). This portal 401 also allows a resident to view his/her payment history, and any payments that have been scheduled in the future. A resident may also change his/her password through the portal 401. As shown at block 402, the components of the community portal allow residents to make all the same payments as the resident portal, in addition to Checkscan. The community manager may access with the community portal certain community management functions as well, including viewing the payment history for the community, viewing the scheduled payments for the community, preparing email reports, and viewing deposit reports. Further, from the community portal the community manager may manage resident access, including system setup procedures as will be described in greater detail below, and also changing the community manager's password.

In further embodiments, payment may also be made by telephone, for example a 1-800 number corresponding to a particular rental community, or particular property management company or partner bank. An electronic voice recognition system or other IVR (interactive voice response) technology may allow the renter to speak, or use the keypad to enter, all of the required rent payment and identification information, as discussed above with regard to the rental portal, to effectuate payment using, for example, credit card or ACH. The IVR system may receive this payment information, and thereafter send such data to the data processing system of the NBFI, in the manner as would be done with data entered into the screens of a resident portal at a website.

### Payment Intake Component and First Transaction Directing Component

The presently described system, in some embodiments, may include a payment intake component 140 (FIG. 1c) for processing the renters' payment order data to initiate a credit to the property management company account at the partner bank. This processing may include recognizing a tag field that serves as the partner bank “identifier,” which may be a number, alphanumeric string or other identifier, to identify the payment as directed to a property management company account. Processing may also include deriving from the payment order the partner bank “identifier” by finding an association between a property or property management company and a partner bank with an account for the property management company. (Logic as in component 184, FIG. 1b, may also be used).

The payment intake component 140 may be configured to receive and identify payment order data which was entered into the rental or community portal, or using the telephonic system, in card (which may include credit card, check card, prepaid card, or any other type of card usable to initiate a payment—“CC”, for “credit card”, is depicted in FIG. 1c, reference numeral 191d, merely as an example type of card), ACH, or Checkscan format. The payment intake component may be in direct electronic communication with the respective portals, such that payment order data, including payment type, amount, community and resident data is received into the NBFI system 190 via this component. The payment intake component may then parse the received data, and based on this data, may associate the data with a particular property management or rental community bank account at the partner bank.

The presently disclosed system, in some embodiments, may include a first transaction directing component operated by the NBFI for responding to the payment order data, NBFI partner bank identifier and specified payment type (sent from the payment intake component) to process a payment order under partner bank processing rules 189a (FIG. 1b) and direct a payment file, which may include card, ACH, or Checkscan check image processing information, for processing to an NBFI partner bank payment processing system for the specified payment type. In this manner, the NBFI partner bank payment processing systems effect a credit in the account at the partner bank of the specified property management company.

The first transaction directing component may be configured and apply processing rules 189a to direct payment through one of several partner bank payment systems, which may include card, ACH, and Checkscan. The specific payment processing requirements and procedures of each payment method are outlined below.

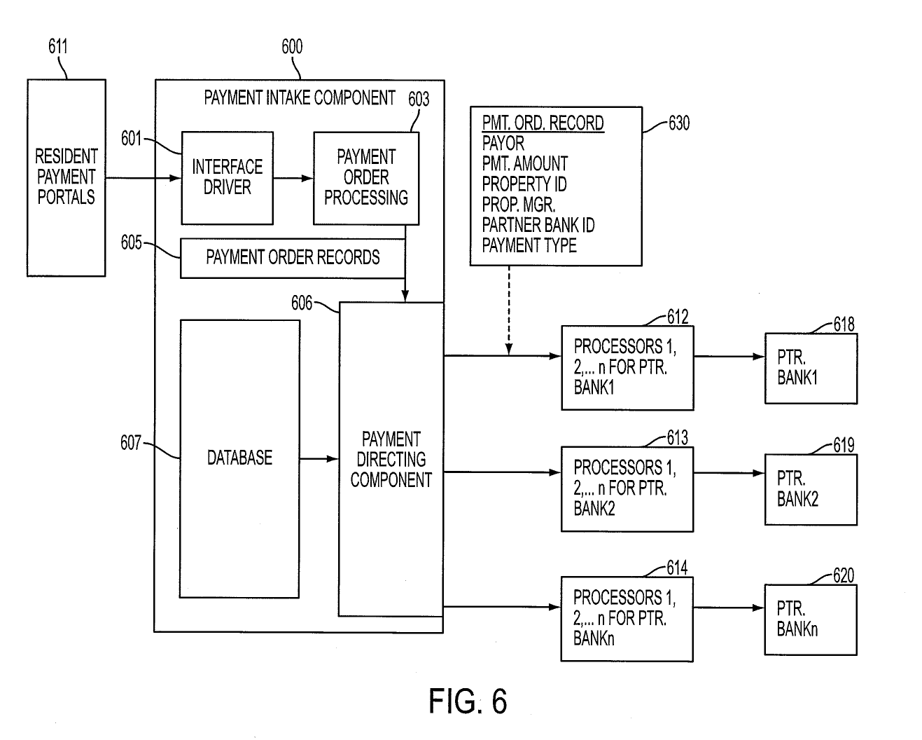

FIG. 6 depicts an example diagram of a payment intake component 600 and a first transaction or payment direction component 606 in accordance with one embodiment of the present disclosure. Payment order data is received from the payment portals 611, which may include the resident portal, the community portal and the telephonic payment system, into the interface driver 601, which uses the interface data shown in FIG. 7 as stored in database 196. The interface driver 601 presents the screens, scripts or other interface elements to elicit and accept payment order instructions, and delivers the instructions to the payment order processing component 603. Payment order processing component 603 parses the payment order data, and stores the data as payment order records 605 (fields are shown at example record 630).

The parsed data is then delivered to the payment directing component 606, which associates the parsed payment order data with a particular partner bank. Such association may be determined by an identifier tag or other data within the payment order identifying the payor, the payment amount, the property identification, or the property management company. The payment directing component may use information about the renters and the property management companies stored in a database 607 in order to make this association. If not yet included in the payment order, the payment directing component then associates a partner bank identifier with the payment order data, and using this identifier and the payment type, applies white label processing rules to direct the payment order data to one of groups of payment processors 1 through n (612, 613, 614) associated with partner banks 1 through n (618, 619, 620). In this manner, through association of a payment order with a particular partner bank and its rules, using data from both the payment order itself and also data stored within a database of the NBFI system, the first payment directing component 606 is able to direct the payment order data to a particular payment processor for the type of payment made and associated with a particular partner bank, and in the proper data format for such form of payment.

Thus, payment order data which is received into the payment intake component is effectively transformed into data in the format of an electronic payment of a specific payment type for processing by the processor of that payment type associated with a specific partner bank.

In some situations, not all partner banks may support all types of payment, or have relationships with payment processors for all types of payment. Thus, if a resident chooses to make a payment using a method that is not supported by the partner bank, the NBFI native processing system (as described above with regard to area A of FIG. 1b) may process the payment on behalf of the partner bank, and direct the payment to the appropriate community or management company bank account. This can be effected by a special processing rule contained in processing rules 189a for a partner bank that links 288 (FIG. 1b) the transaction to the transaction submitted component 188 that is part of the NBFI processing area A of FIG. 1b. The NBFI may collect a fee for this processing. In an alternative embodiment, if a particular type of payment is not supported by a partner bank, the resident may not be allowed to use such payment method. Normally, the payment transaction interfaces of a partner bank would only present valid payment processing options for that partner bank.

Specific aspects of the various payment methods accepted by the NBFI system and embodied in white label processing rules will now be discussed. With regard to credit card processing, a payment order may be initiated online through the resident portal, community portal, or via a telephonic text or IVR system or similar portals. Card processing begins with authorization. The cardholder indicates a payment of rent (and possibly other amounts due) and the NBFI system or partner affiliated processing service submits the transaction for verification to the issuer of the card, which verifies the card number and expiration, the transaction type and the amount, and card status. The system may also use CVV, CVS, or AVS information for further verification. An authorization will generate an approval code, which the NBFI stores with the transaction. Authorized transactions may be stored in batches, which are typically submitted once per day at the end of the business day. The NBFI then sends batched payments for clearing and settlement through partner bank's credit card processing company. The batched transactions are submitted through the credit card association via the processing company, which debits the issuers for payment and credits the respective partner bank account via the merchant services system of the partner bank. The merchant services system of the partner bank receives the amount totaling the funds in the batch. The partner bank may also charge a fee for accepting the rent payment through its merchant services system.

In the case of ACH processing, a particular efficiency is available. The NBFI partner bank ACH payment processing system may perform a file merge for payment files representing ACH credits and debits of a property management company over a defined period to reduce the number of ACH transactions for which the property management company pays fees.

### Second Transaction Directing Component

In some embodiments, the payment platform and system of the NBFI disclosed herein may further include a second transaction directing component (not shown in FIG. 6, but may be included with payment directing component 606) operated by the NBFI for directing payment processing for payments to specified property management company accounts made by payment means not offered by the NBFI partner bank. Such payment means, and associated processing systems, operated by the NBFI may include direct money transfer, proprietary pinless debit, and other known payment methods less commonly processed by banks. The respective NBFI payment processing system may then settle with the partner bank to effect credits to the account of the specified property management company. Thus, instead of a transaction proceeding to the point at which the partner bank processing rules are applied, the payment transaction type not supported by the partner bank can be recognized at controller 184 and treated as a non-white label transaction via referral path 288. In this case, the payment transaction interfaces of the NBFI system may be used to prepare the payment transaction and it will be processed by the NBFI payment processing systems. As long as the payment transaction leads to a payment at a bank account recorded by the NBFI, it is traceable for settlement purposes. Such a situation may occur when a renter seeks to make a payment by accessing a partner bank portal but is unable to complete a desired payment transaction, e.g., due to a credit card limit. If the partner bank can smoothly link the renter to an NBFI payment portal where the renter can use another form of payment not offered by the partner bank, the payment will be made. Although such a payment will not follow a path favored by the partner bank, the property management company will be pleased to have received the payment.

In one example, such alternative NBFI payment processing systems may include direct money transfer, such as that offered by MoneyGram, Inc. In this manner, the renter may access the payment systems of the NBFI either online by link from the resident portal, or through an agent location of the NBFI. Payment through the resident portal may be made in the same manner as the payments described above, by entering the required information to process the payment. Alternatively, the renter may pay rent by cash at an agent of the NBFI. This agent may have access to the NBFI rental payment platform, which may include an agent portal, configured to receive rent payment information for all or selected ones of the rental property communities which the NBFI platform serves.

In an alternative example, NBFI payment may be made through a proprietary pinless debit transaction on a card not supported by the partner bank, wherein the renter supplies the information on a debit card to the payment system of an NBFI.

### Billing File Component

The presently disclosed system, in some embodiments, may include a billing data file component operated by the NBFI for reporting to the NBFI partner bank the payment orders directed to each of the property management companies with an account held at the NBFI partner bank. With this data, the partner bank can settle the fees for payment processing with the NBFI.

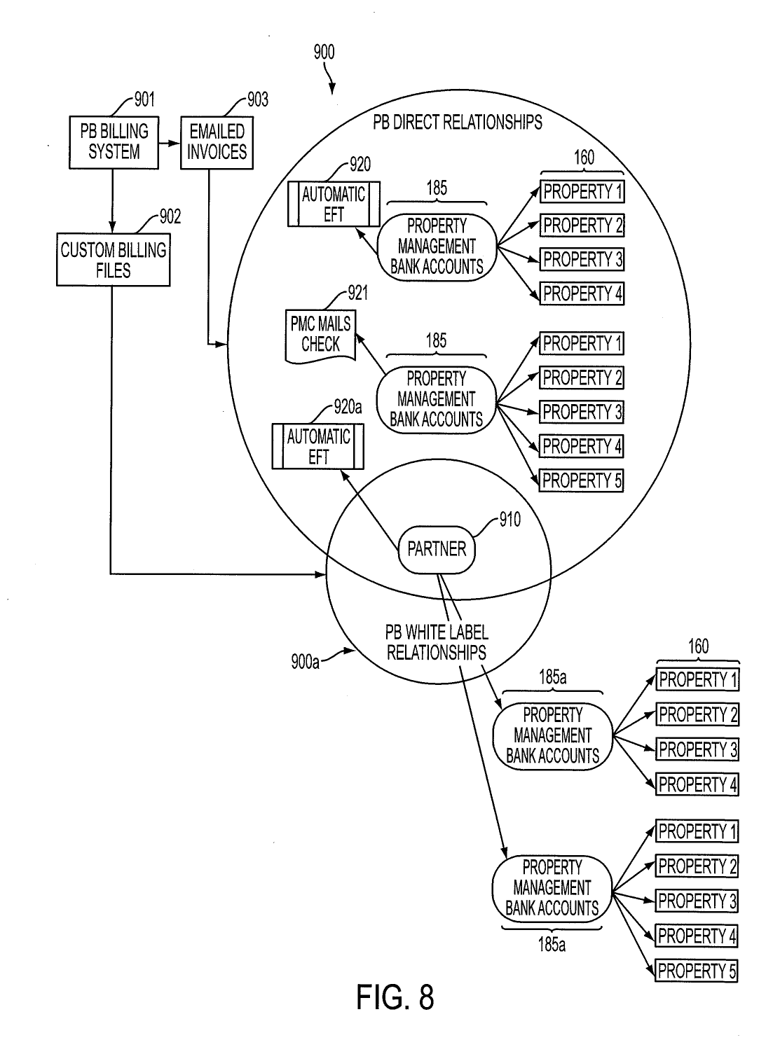

FIG. 8 depicts a relationship diagram of the billing file function of the NBFI in accordance with one embodiment of the present disclosure, and shows how this may be added to the systems of the prior art. In the prior art, at block 900, emailed invoices 903 prepared by the billing file component 901 are sent to property management companies for payments processed through the NBFI system. The property management companies remit payment either through electronic funds transfer 920 or by submitting a paper check 921 to the NBFI for its services.

As shown in FIG. 8, the system of the present disclosure, within the context of the white label partner bank relationships 900a described above, a partner bank 910 receives custom billing files 902 prepared by the billing file component 901. The partner bank acts as an intermediary between the NBFI and the property management companies that are clients of the partner bank, taking fees for its payment processing services, and remitting fees to the NBFI for its system's services via electronic funds transfer 920a. Thus, settlement of the NBFI fees occurs without any interference with the partner bank's account holding clients.

### Payment Data Interfaces

FIG. 5 shows the primary features of the payment data interfaces at the resident portal 401, community manger portal 402, corporate portal 403 which are all accessed via a partner bank and the partner bank portal 404 which is accessed directly via the NBFI system. Block 402 shows the elements described above with regard to FIG. 3, in addition to the resident access features described previously. At a corporate portal 402 or property management company payment data interface (portal) 403, a corporate user may review data from its property management companies and a property management company may set up email reports for its rental communities, and may view deposit reports for its rental communities. The property management company may also manage the community managers' access to the system, and it may change their passwords. At a partner bank payment data interface (portal) 404, the partner bank may view deposit reports, payment history, or scheduled payments at either the community level or by client/property management company. The partner bank may also access Checkscan batches for a given time period, and set up email reports for client property management companies. Administratively, the partner bank may use the interface 404 to manage partner bank level access for the partner bank's employees, including passwords, manage client property management company access, including passwords, and manage community manager access, including passwords.

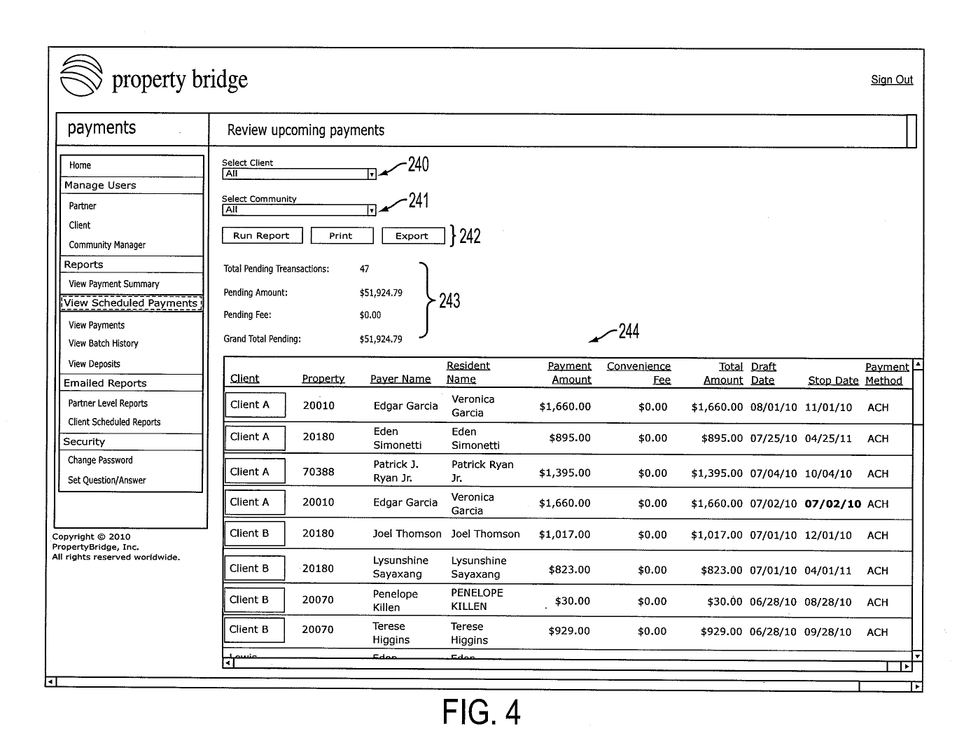

FIG. 4 depicts an example partner bank payment data interface as described above. The left side column shows the selection of the specific functionality of the interface. Depicted in FIG. 4 is the “View Scheduled Payments” functionality, which allows the partner bank to view scheduled payments at some or all of its communities. At selection 240, the client is selected, for example, the property management company. At selection 241, the residential community is selected. At selection 242, the user may choose to run a report, print a report, or export a report. Information 243 shows the cumulative information regarding scheduled payments, including total pending transactions, pending amounts, pending fees, and grand total pending. Furthermore, a display 244 shows information regarding payments of each resident at the selected community, including property (community), payer name, resident name (which may be the same), payment amount, fee, total amount, draft date, stop date, and payment method. Thus, using this interface, the partner bank can effectively manage and oversee the payments from its client properties.

### Renter Information Receipt and Payment Validation

Referring again to FIG. 1c, the NBFI platform information system 190 may be configured to receive rental data files regarding renters from a property management company or a rental community, or from a property management software company. Information that the property management company or rental community may supply to the NBFI platform may include renter name, unit rented, rent amounts, bank account information, credit card information, payment history, or any other information which may otherwise be received from a renter by the NBFI platform through, for example, the renter portal, and require confirmation, validation, or other processing.

Information received into the system configuration component may be stored in one or more of databases 195 or 197 and used by the NBFI platform and system 190 to validate information received during payment processing. For example, if a particular renter at a particular rental property makes a payment for $500, but the NBFI system has stored information that the monthly rent due for that particular renter is $600, then the system may either reject the payment, or accept the payment and provide an indication to the renter through the portal and interfaces that there remains a deficiency in the payments made. In another example, information received from the property management company into the NBFI system may be used to validate information received from a putative renter during an account creation process. Prior to using the NBFI payment platform for the first time, the renter may be required to supply the system with certain personal information. The system configuration component may then validate the account based on information previously supplied by the property management company or rental community during a setup procedure and stored by the NBFI for use in account creation.

Information supplied by the property management company and received into the system configuration component may also be used to configure the billing file component. For example, payments made into the system with associated payment order data which correspond to previously entered renter data may be stored and filed accordingly by the billing file component, and easily categorized for compatibility with the data files built by conventional property management software (including, for example, the Yardi Voyager™ system from Yardi Systems, Inc., in addition to systems from AMSI Property Management, MRI Software, PropertyView Solutions, and RealPage Inc., among others) which would also contain such renter information.

Although the present disclosure has been described with respect to various embodiments, persons skilled in the art will recognize that changes may be made in form and in detail without departing from the spirit and scope of the present disclosure.

What is claimed is:

1. A computer-based system operated by a non-bank financial institution (NBFI) for receiving and processing payments made by renters to property management companies, comprising:
a memory for storing payment interface data defining interactions with a renter to receive payment order data specifying a rent payment to a specified property management company customer of an NBFI partner bank, said payment having an amount and a specified payment type;
a controller responsive to a renter log-in or access to select from the memory payment interface data for an NBFI partner bank identifiable from the renter log-in or access and to drive payment interface interactions to receive payment order data;
a payment intake component for applying NBFI partner bank processing rules stored by the system to process the payment order data and initiate a credit to an account of the specified property management company;
a first transaction directing component for responding to the processed payment order data and specified payment type to direct a payment order record for processing to an NBFI partner bank payment processing system for the specified payment type, said NBFI partner bank payment processing system effecting a credit in the account of the specified property management company; and
a billing file component for reporting to the NBFI partner bank payment orders directed to each of a plurality of property management companies that are customers of the NBFI partner bank, whereby the partner bank can settle the fees for payment processing by the partner bank payment processing systems.

2. The system of claim 1, further comprising a second transaction directing component operated by the NBFI for directing payment processing for payments to specified property management company accounts but made by payment means not offered by the NBFI partner bank to NBFI payment processing systems, said NBFI payment processing systems settling with the partner bank to effect credits to the account of the specified property management company.

3. The system of claim 1, wherein the payment interface data define at least one payment interface selected from the group consisting of an on-line website interface; an IVR interface; and a check scanning interface.

4. The system of claim 1, wherein the NBFI partner bank payment processing system comprises a payment processing system selected from the group consisting of: a card payment processing system, an ACH payment processing system, C21 check image processing system, a pinless debit processing system, and a cash payment processing system.

5. The system of claim 1 further comprising a system configuration component for receiving from a property management company customer of the NBFI partner bank renter and billing status data that permits a payment interface to validate proposed payment order data for a renter against the billing status data of the renter.

6. The system of claim 1 further comprising a property management company portal that permits a property management company customer of an NBFI partner bank to view payments directed to a property management company account resulting from payment orders received at the least one payment interface.

7. The system of claim 1, wherein the NBFI partner bank processing rules of an NBFI partner bank stored by the system specify that at least one payment type is processed by an NBFI payment processing system instead of a NBFI partner bank payment processing system.

8. A computer-based system operated by a non-bank financial institution for receiving and processing payments made by renters to property management companies, comprising:
a memory for storing payment interface data defining interactions with a renter to receive payment order data specifying a rent payment to a specified property management company customer of an NBFI partner bank, said payment having an amount and a specified payment type;
a controller responsive to a renter log-in or access to select from the memory payment interface data for an NBFI partner bank identifiable from the renter log-in or access and to drive payment interface interactions to receive payment order data;
a payment intake component for applying NBFI partner bank processing rules stored by the system to process the payment order data and initiate a credit to an account of the specified property management company;
a first transaction directing component for responding to the processed payment order data and specified payment type to direct a payment order record for processing to an NBFI partner bank payment processing system for the specified payment type, said NBFI partner bank payment processing system effecting a credit in the account of the specified property management company; and
a billing file component for transforming the payment orders directed to each of a plurality of property management companies that are customers of the NBFI partner bank into a report to the NBFI partner bank, whereby the NBFI partner bank can settle the fees for payment processing by the partner bank payment processing systems.

9. A computer-based method operated by a non-bank financial institution for receiving and processing payments made by renters to property management companies, comprising:
storing in a memory payment interface data defining interactions with a renter to receive payment order data specifying a rent payment to a specified property management company customer of an NBFI partner bank, said payment having an amount and a specified payment type;
operating a controller responsive to a renter log-in or access to select from the memory payment interface data for an NBFI partner bank identifiable from the renter log-in or access and to drive payment interface interactions to receive payment order data;
operating a payment intake component for applying NBFI partner bank processing rules stored by the system to process the payment order data and initiate a credit to an account of the specified property management company;
operating a first transaction directing component for responding to the processed payment order data and specified payment type to direct a payment order record for processing to an NBFI partner bank payment processing system for the specified payment type, said NBFI partner bank payment processing system effecting a credit in the account of the specified property management company; and
operating a billing file component for reporting to the NBFI partner bank payment orders directed to each of a plurality of property management companies that are customers of the NBFI partner bank, whereby the partner bank can settle the fees for payment processing by the partner bank payment processing systems.

10. The method of claim 9, further comprising operating a second transaction directing component for directing payment processing for payments to specified property management company accounts but made by payment means not offered by the NBFI partner bank to NBFI payment processing systems, said NBFI payment processing systems settling with the partner bank to effect credits to the account of the specified property management company.

11. The method of claim 9, wherein the payment interface data define at least one payment interface selected from the group consisting of: an on-line website interface; an IVR interface; and a check scanning interface.

12. The method of claim 9, wherein the step of operating a first transaction directing component comprises directing a payment order record to an NBFI partner bank payment processing system, said payment processing system selected from the group consisting of: a credit card payment processing system, an ACH payment processing system, a C21 check image processing system, a pinless debit processing system, and a cash payment processing system.

13. The method of claim 9 further comprising operating a system configuration component for receiving from a property management company customer of the NBFI partner bank renter and billing status data and operating a payment interface to validate proposed payment order data for a renter against the billing status data of the renter.

14. The method of claim 9 further comprising operating a property management company portal that permits a property management company customer of an NBFI partner bank to view payments directed to a property management company account resulting from payment orders received at the least one payment interface.

15. The method of claim 9, wherein the step of operating a payment intake component for applying NBFI partner bank processing rules comprises applying NBFI partner bank processing rules specifying that at least one payment type is processed by an NBFI payment processing system instead of a NBFI partner bank payment processing system.
